(19) United States
(12) Patent Application Publication
(10) Pub. No.: US 2007/0295334 A1
(43) Pub. Date: Dec. 27, 2007

(54) Virucidal/germicidal mask

(76) Inventor: Arthur M. Nonomura, Litchfield Park, AZ (US)

Correspondence Address: NIELDS & LEMACK, 176 EAST MAIN STREET, SUITE 7, WESTBORO, MA, 01581, US

(21) Appl. No.: 11/732,047

(22) Filed: Apr. 2, 2007

Related U.S. Application Data
(60) Provisional application No. 60/789,484, filed on Apr. 5, 2006.

(51) Int. Cl. A62B 18/02

(52) U.S. Cl. 128/206.13; 128/206.12; 128/206.19

(57) ABSTRACT

The present invention provides a mask, suitable for wearing, that inhibits the passage of viruses and germs there through. Briefly, the mask comprises a number of individual layers. Each of these layers is treated with a compound designed to destroy viruses and germs, thus retarding the passage of viruses and germs to the next layer, and ultimately to the user. In one embodiment, a layer of acidic material and a separate layer of basic material are utilized in a form suitable to be placed over the user's nose and mouth.

This application claims priority of Provisional Application Ser. No. 60/789,484 filed on Apr. 5, 2006, the disclosure of which is incorporated herein by reference.

### BACKGROUND OF THE INVENTION

It is well known that numerous viruses are easily transmitted between people through direct and indirect contact. For example, rhinoviruses, thought to be the cause of the common cold, are easily communicated from an infected person to the next unsuspecting victim. This communication can be direct, which may occur when two people are in close proximity. Air exhaled by the infected person, or discharge such as via a cough or sneeze, causes the virus to become airborne, facilitating its transfer to another person. It is also believed that viruses can be transmitted via indirect contact. This occurs when there is at least one intervening surface between the two persons, such as a tabletop, a doorknob, or even one's hand.

Inhaled airborne bacteria and viruses cause infection and disease and pose a danger if spread accidentally or intentionally in the atmosphere. This problem is exacerbated in enclosed environments, such as commercial airliners, where a single passenger can spread infectious disease organisms throughout the cabin. Various approaches have been attempted to combat the threat of bioparticulate contamination through the use of HEPA filters, hoods and gas masks that were designed to filter out or adsorb general microorganisms that might otherwise be breathed in by a person coming into contact with microbes.

Several attempts have been made to solve this problem. For example, U.S. Pat. No. 6,681,765 discloses a gas mask with a filter cartridge and a germicidal pellet. The gas mask includes a passive stage filter that blocks passage of particulates and an active stage germicide designed to kill microbes. The gas mask is a full face mask covering eyes, nose and mouth. This mask is cumbersome and awkward to wear, thus limiting its usefulness, which reduces its effectiveness.

An attempt to reduce the spread of microorganisms led to the development of U.S. Pat. Nos. 4,738,847 and 4,828,912, which disclose a tissue, having virucidal components embedded within the tissue. As disclosed, this tissue is effective at killing rhinoviruses, influenza A and influenza B; but does not demonstrate virucidal efficacy against avian influenza. Furthermore, the tissue is meant to prevent spread by hand contact with the tissue and not from airborne viruses. This apparently hinders the spread of the virus to others when the tissue is directly or indirectly handled after being laden with pathogens; however, it leaves the uninfected person completely open to airborne viruses. This is problematic, especially in the case of widespread illness. For example, when millions of people have the common cold, it is naive to believe that airborne pathogens will not be inhaled. This problem becomes far more serious when the virus in question is not the common cold, but rather is a more dangerous airborne pathogen, such as the looming Asian bird flu pandemic that is predicted by many experts. The tissue is not designed for air passage and, in fact, interferes with the breathability required of a respirator by reducing air flow.

Another similar attempt to reduce the spread of microorganisms led to the wide dispersal of hand sanitizers, mostly containing ethanol. These surface-sanitizing systems are effective at reducing spread by hand contact but they are ineffective at protecting against airborne viruses The infected person uses these alcohol-based sanitizers to kill viruses that would have been picked up by others handling the germ-laden surfaces. This method of hindering the spread of the virus from the hands of one to another's is impractical in a mask because of the resultant inhalation of alcohol vapors. Like the tissues, hand sanitizers do not protect against inhalation of airborne viruses.

A device that allows people to protect themselves from viral pathogens would be very beneficial in stopping the spread of viruses. The system may be especially helpful in reducing the effects of widespread epidemics.

### SUMMARY OF THE INVENTION

The shortcomings of the prior art are overcome by the present invention, which provides a mask, suitable for wearing, that inhibits or prevents the passage of active viruses and live germs there through and kills the virus. Briefly, the mask comprises a number of individual layers, at least some of which are substrates for a virucidal composition. Certain layers are treated with one or more compositions effective for inactivating or destroying viruses and germs, particularly respiratory viruses, thus retarding or preventing the passage of live viruses and germs to the next layer, and ultimately to the user. In one embodiment, a layer of acidic material and a separate layer of basic material are utilized in a form suitable to be placed over the user's nose and mouth.

### BRIEF DESCRIPTION OF THE DRAWINGS

FIG. 1 represents a first embodiment of the invention; and

FIG. 2 represents a second embodiment of the invention.

### DETAILED DESCRIPTION OF THE INVENTION

Reducing the spread of viruses and bacteria could thwart the spread of influenzas and pandemics. By protecting the user's nose and mouth so that microorganisms are inactivated or destroyed before they enter the user, or conversely, before the germs can be dispersed into the general population, the spread of these microbes can be significantly reduced.

A protective respirator, suitable to be easily worn as a mask, allows the users to reduce their potential exposures to infectious microorganisms. In one embodiment, a semi-rigid mask having a shape similar to that of a dust mask is utilized. In a second embodiment, a more flexible mask, similar to a surgical mask is used. While these are preferred embodiments, the invention is not so limited and other types of masks are also within the scope of the invention.

Preferably, the mask includes fastening devices, such that they can be worn over the user's nose and mouth without the user holding the mask in place. These fastening devices can be varied in type and include: an elastic material, attached to at least two points on the mask that circumscribes the user's head; materials suitable for tying attached to at least two points on the mask that are then tied together behind the user's head; and two pieces of material, preferably elastic, each in the shape of a loop, attached to the left and right sides of the mask respectively and suitable for placing behind the user's ears. This list is meant to be illustrative of the possible fastening devices that can be used. However, it should not be construed as limiting the invention to only these fasteners.

In each of the described embodiments, the respirator comprises a number of layers that are substrates for one or more germicidal or virucidal composition and that inhibit or prevent the passage of pathogens to the user. Additionally, passive bacterial and viral filtration can be achieved via one or more tightly woven or nonwoven layers. Alternating layers of acidic and basic layers is an effective combination of environments that will destroy most pathogens. Most viruses and germs have only a limited tolerance to pH, with most active only between roughly pH 6 to 8. By incorporating at least one acidic environment, with a pH preferably of about 3 or less, and at least one basic environment, with a pH of preferably about 10 or more, the nucleocapsid and nucleic acids of most viruses will be neutralized upon exposure to these environments. By separating the acidic and basic compounds on two different layers, there is little risk that the compounds will be neutralized by one another, as is possible if a surfactant is used with an acidic compound.

Suitable layers or substrates for the virucidal compositions include woven materials, such as tightly woven microfibril cloth; tightly woven cotton cloth; absorbent cellulose fiber layers; woven fabrics; textiles; and non-wovens such as polymer-laid fabrics, including spunbonded and meltblown materials, dry-laid and wet-laid non-wovens, etc. Miocrofibril substrates are preferred because the germicidal compositions sit on the surface of the polyester fibrils and reside at 100% concentration on the surface of the fibrils. Woven fabric such as muslin also facilitates respiration by the user compared to non-woven layers.

Suitable acidic virucidal compositions that can be infused on the substrates include acids or salts or esters thereof, such as citric acid, any carboxylic acid (R—COOH), or any mineral acid. Alternatively, citrate esters and Vitamin C esters are milder than citrus acid and can be utilized. Particularly preferred antivirals are the substrates of the Krebs Cycle (tricarboxylic acid cycle), which include pyruvate, citrate, isocitrate, ketoglutarate, succinate, fumarate, malate and oxaloacetate. Krebs Cycle components citrate and malate, adjusted to an acid pH below 5, are especially preferred, as are the esters of Krebs Cycle intermediates. The amount of the acid (or salt or ester thereof) should be sufficient to form a virucidally effective amount on the substrate. In certain embodiments, an effective amount of the acidic virucidal composition in a layer is an 11%-100%, more preferably 11% to 30% of the acid, salt or ester.

Suitable basic virucidal compositions include soaps; sodium lauryl sulfate (SLS); quaternary ammonium salts; cationic, anionic and nonionic surfactants; and other surfactants, such as tallow amines. The amount of the base should be sufficient to form a virucidally effective amount on the substrate. In certain embodiments, an effective amount of the basic virucidal composition is 0.1-100%, more preferably 0.2% to 30%, of the surfactant, salt or ester.

Other suitable virucidal compositions that can be infused or incorporated into one or more substrates include metallic virucides/germicides, such as zinc disodium EDTA, copper, nickel, iodine, manganese, tin, boron, or silver; salts thereof; chelants thereof, chelactants (such as ethylenediaminetriacetic acid) thereof; surfactant-linked compositions thereof; or ions thereof. In certain embodiments, an effective amount of the metal virucidal composition is a 1-100% solution of the metal. Still further virucides include colloids and phycocolloids, such as agar and carrageenan.

Depending on the state of the virucide, various commercial methods to imbue the substrate can be applied. For example, liquid virucides may be misted, sprayed, sputtered, painted or soaked into the substrate. Solids may be pelleted or powdered and applied evenly in a dry-coat; rolled; aerially dispersed; dry-sputtered; evaporated; pressured; and vacuum incorporated. Dry powders may also be ground into nanoparticles or suspended and emulsified in a liquid for applications that coat the substrate. Gels may be treated like a liquid coating with preference for soaking and expressing surplus liquid for recovery. Oils may be directly applied as a liquid. Drying may be undertaken with mild heat (20 to 100 degrees C) and sterilization may be undertaken with heat from 100 to 200 C.

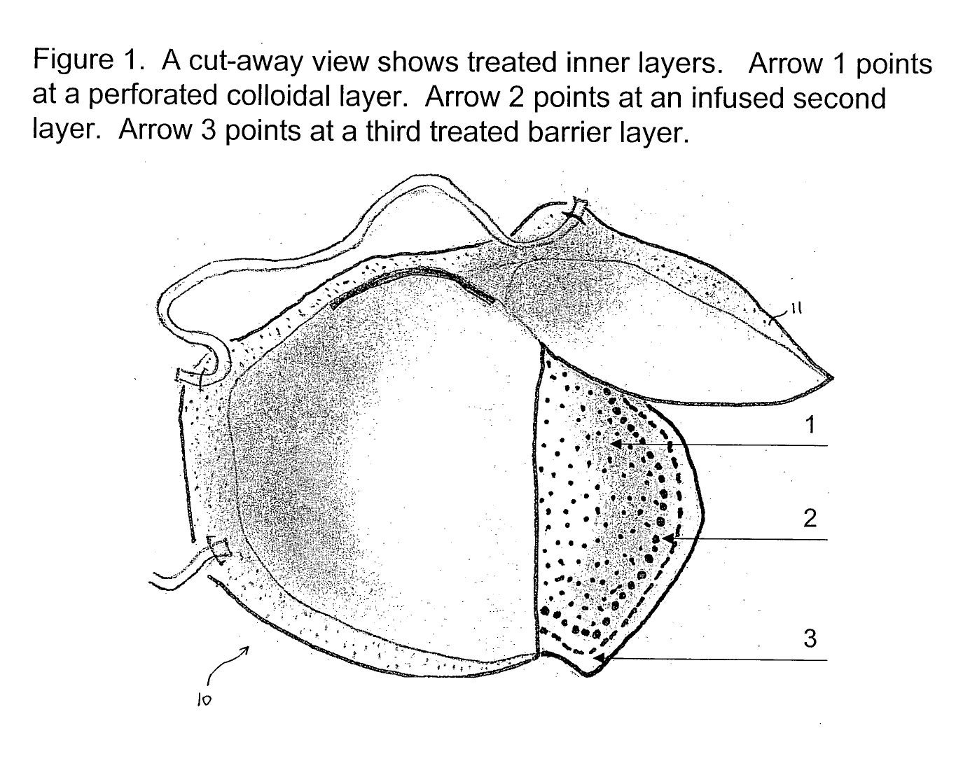

In a first embodiment, shown in FIG. 1, a mask is shown generally at 10 with a portion 11 cut away to make visible a plurality of inner layers of the mask. In the embodiment shown, there are three layers, although those skilled in the art will appreciate that the number of layers is not particularly limited. In this embodiment, each of the layers is a tightly woven substrate that has been treated with one or more appropriate compositions in accordance with the invention. These treated layers are preferably enveloped within untreated outer layers, so as to minimize potential irritation to the user's skin. Layer 1 is a layer infused with a perforated colloid such as agar. Layer 2 is substrate infused with a virucidal composition such as an acid or base, as described above. Layer 3 is a barrier layer also treated with a virucidal composition such as an acid (particularly if layer 2 is infused with a base) or a base (particularly if layer 2 is infused with an acid), or a metal such as chelated zinc.

In a second embodiment, a dust mask, such as those commercially available from 3M and others, is retrofitted to transform it into a protective respirator having germicidal and virucidal activity. Masks are intended to filter particulates, not germs; several are rated to filter particulates as fine as 1 micron, thus allowing filtration of many large bacteria as well as larger pollens and fungi. Of particular interest are N95 particulate-rated respirators. N95-rated protection is based on tested filters that effectively stop 95% of solid non-oil particulates. Generally, in an aerial dust environment such as a workshop, the respirator must pass tests that show that it prevents leakage of 95% of solids to 0.3 micron diameter; and therefore, the antiviral mask must be capable of blocking passage of 95% of particulates that are greater than or equal to 0.3 micron diameter. The standard test will be equivalent to blocking passage of 95% of particulates equivalently down to 1 micron-tested glass filters, e.g. Gelman A/E and Whatman Grade GF/B. The service time limit for Nseries-rated protection should only be extended beyond 8 hours of continuous or intermittent use in environments where the total mass loading of the mask is less than 200 mg; and, furthermore, they should be used and reused subject only to considerations of hygiene, damage, and resistance to breathing. An N100-rated mask is designed to stop 99.97% of particulates to 0.3 micron, however, this level of filtration has greater resistance to breathing, costs more to manufacture, and requires more frequent changes of filters than N95-protectors.

Simple blockage of particulates is not necessarily effective against viruses because they may become substantially smaller than 0.1 micron diameter, as a carrier, such as a liquid mucous droplet, evaporates. Wherein, flu-infested mucous is captured by the respirator, it is essential for the virus to be killed in the respirator in order to prevent further transport of the virus that would result in infection. In the case of the respirator without virucidal capability, e.g. the N100 filter, it is possible that out of 1000 viruses captured, they or their nanoscalar parts may be released back into the air; and the potential for infection becomes a reality. With the virucides inserted, blockage and kill is completed.

Many of these masks comprise an exterior having non-woven layers, with one or more inner layers. These inner layers can either be replaced with treated layers, or can be treated with virucidal/germicidal components. In one embodiment, a first inner layer is coated with a basic material, such as a soap powder or other alkaline. A second layer is infused with a zinc salt, or any metallic virucide/germicide, such as those enumerated above. The third layer preferably is treated with an acid, such as citric, ascorbic, mineral or any carboxylic acid, salt or ester. In such an embodiment, the total weight of the germicidal/virucidal components is less that 2% of the total substrate weight.

In a third embodiment, the inner layers of the mask of the second embodiment are replaced. A first layer is infused with zinc salt, or any other metallic virucide/germicide. A second layer contains a deodorant that optionally can have germicidal activity, such as germicidal oils, including wintergreen, spearmint, peppermint, eucalyptol, cedar, pinene and other tree oils, or limonene, lemon oil, and other citric oils. With a third tallow amine surfactant layer, the mask is virucidal against strains of influenzas, rhinoviruses, RSV, and adenovirus. The total weight of the germicidal/virucidal components is preferably less than 25% of the total substrate weight.

In yet another embodiment, a face mask comprised of all natural germ fighting agents is utilized. A first inner layer comprises a soap powder, at low concentration, such as 1%. A second inner layer comprises a natural germicide, such as lemon juice (or its crystals), limonene, and wintergreen. A third layer, comprising a natural deodorant, such as wintergreen, spearmint or any of the other deodorants listed above, is utilized. The concentration of the deodorant is preferably low, such as in the 0.001% to 0.1% range.

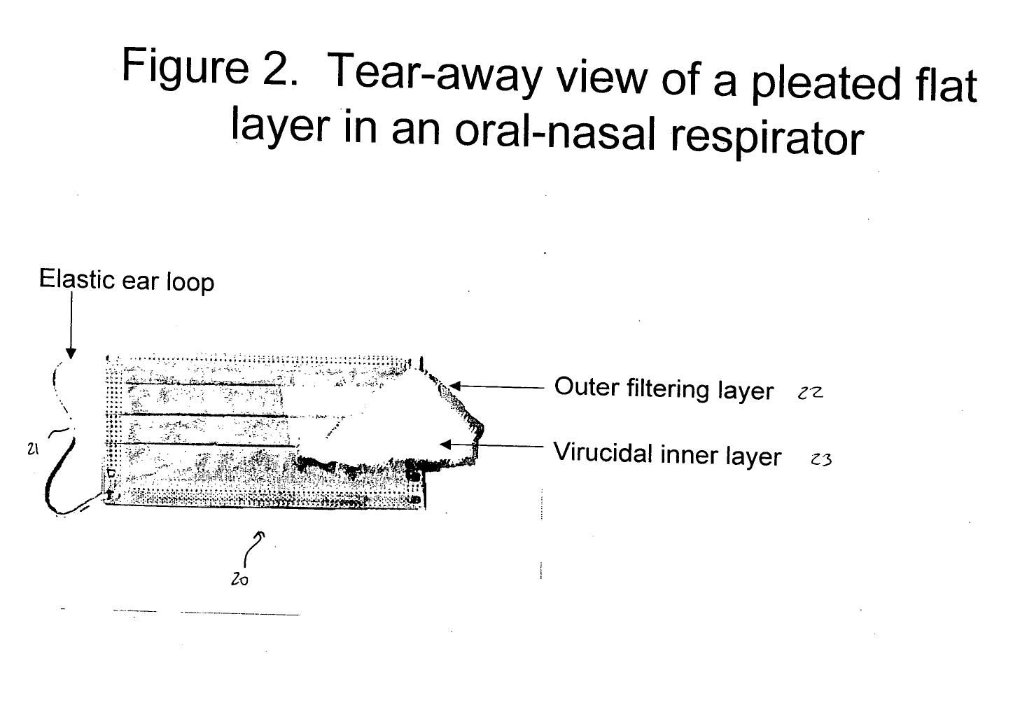

In another embodiment, a mask, similar to a surgical mask, as shown in FIG. 2, is used in place of the dust mask. This surgical mask can be used in conjunction with any of the various embodiments listed above. Thus, mask 20 includes a fastener 21 such as one or more elastic ear loops attached to corners of the mask body. An outer filtering layer 22 is provided, as well as one or more inner virucidal layers 23.

Methods for assembly of a dust mask type of virucide protector were undertaken as by the following example. A plastic snap-together frame with elastic ear straps was opened and the virucidal layers were prepared for insertion. The first layer contained nonionic surfactants. The second layer was a tightly woven nylon mesh (e.g. Nitex® 100 micron bolting cloth) that was dipped to wetness in hot 0.5% agar-zinc chloride solution and followed by blowing the warm gel out of the open weave for free flow of air between the coated fibers. This second layer was allowed to dry under mild heat, 70° to 120° to a flexible state inserted for virucidal action against retroviruses. The final layer was a woven microfibril layer that had been infused with 0.1% to 10% wintergreen deodorant. The layers were cut to fit the frame of the mask and snapped in. The mask was worn over the nose and mouth and provides protection against airborne influenza, avian influenza, adenovirus, rhinovirus, and retroviruses.

Each of the above embodiments can be improved by inserting a perforated phycocolloid layer. It has long been recognized that phycocolloids have low antiviral activity, but they have not as yet been incorporated into a respirator. Phycocolloids, such as agar, carrageenan, seaweed extracts, and the like, improve the structure of the face mask; act as adhesives that affix salts and powders to the substrate; and can be activated by the moisture of exhalation to become sticky. 0.1% to 100% Phycocolloids can be applied to woven or non-woven substrates, such as by dipping and drying, or they may be made into a thin-layered sheet that can be perforated for ease of breathing.

In the case of the thin-layered sheet, a 3% agar solution, for example, can be dissolved in boiling water and allowed to cool, such as to 60° C. A single layer of zinc metal powder may be pre-applied to a flat surfaced vessel that the agar gel is set in, allowing a convenient means of releasing the gel after it is dried. The agar gel is then spread to 0.1 cm to 1.0 cm thickness on the flat surface. While wet, powders of antiviral components, such as carboxylic or citric acid crystalline powder, are sprinkled over the wet top surface of the agar gel. The solution is dried, thereby forming a 0.1 mm to 1.0 mm layer of agar. This layer is then micro- or nano-perforated to allow the passage of air from inhalation and exhalation. This layer then serves as an antiviral layer within the respirator.

To maximize the efficiency of the respirator, it is desirable to increase the surface area of the layers over which incoming air must flow. There are a variety of methods that can be used to achieve this result. For example, phycocolloid layers can be melted, sprayed or otherwise applied over corrugations or microfibrils to maximize surface areas. Alternatively, to maximize the surface area over which bioparticles pass, it is advisable to offset the pores of each layer, such that the flow of air is non-laminar.

### EXAMPLE 1

Ten grams of single tightly woven microfibril cloth is soaked in 30% citric acid and allowed to dry. The process is repeated until an accumulated total of 10 grams of citric acid have been absorbed and dried into the cloth.

Cellulosic tissue is sprayed with sodium lauryl sulfate and allowed to dry. The application process is calibrated to an accumulated total of 0.3% to 0.8% of sodium lauryl sulfate weight of the trilaminar system being absorbed into the cellulosic fibers.

Ten grams of tightly woven cloth is sprayed with 9.5% zinc citrate dihydrate and allowed to dry. The process is repeated until an accumulated total of grams of 25%% zinc citrate dihydrate has been absorbed and dried into the cloth.

The three treated cloths are placed layer upon layer between the top and bottom layers of a 3M dust mask respirator and sealed within so that the germicidal layers do not show outside and are not exposed to contact with skin. The resulting respirator can be worn throughout the day to filter particulates and large microbes while all of the Bird Flu virus is killed within the treated layers.

### EXAMPLE 2

A study was carried out to evaluate the virucidal efficacy of a treated fabric against Avian Influenza A (H3N2) virus (Avian Reassortant), ATCC VR-2072, Strain A/Washington/897/80 X A/Mallard/New York/650/78. The protocol was based on ATCC Test Method 100-1999 “Antibacterial Finishes on Textile Materials: Assessment of modified for testing of viruses.”

The A/Washington/897/80 X A/Mallard/New York/650/78 strain of Avian Influenza A (H3N2) virus (Avian Reassortant) use for this study was obtained from the American Type Culture Collection, Manassas, Va. (ATCC VR-2072). The stock virus was prepared by collecting the allantoic fluid from inoculated ten-day old fertilized, embryonated chicken eggs. The fluid was clarified by centrifugation, aliquoted and stored at ≦−70° C. until the day of use. On the day of use, two aliquots of stock virus (ATS Labs Lot IA-58) were removed, thawed, combined, and refrigerated until use in the assay. The stock virus culture was adjusted to contain 5% fetal bovine serum as the organic soil load. The stock virus tested demonstrated cytopathic effects (CPE) typical of Influenza on Rhesus monkey kidney cells.

RMK cells were obtained from ViroMed Laboratories, Inc., Cell Culture Division. The cultures were maintained and used as monolayers in disposable tissue culture labware. On the day of testing, the cells were observed as having proper cell integrity and therefore were acceptable for use in this study.

The test medium used in this study was Minimum Essential Medium (MEM) supplemented with 1% heat-inactivated fetal bovine serum (FBS), 10 μg/ml gentamicin, 100 units/ml penicillin, and 2.5 μg/ml amphotericin B.

The following table lists the test and control groups, the dilutions assayed, and the number of cultures used.

NUMBER OF DILUTIONS AND CULTURES
FOR VIRUCIDAL EFFICACY STUDY

| | | Cultures | |
|---|---|---|---|
| | Dilutions Assayed | Per | Total |
| Test or Control Group | (log₁₀) | Dilution | Cultures |
| Cell Control | N/A | 4 | 4/group |
| Input (Zero Time) Control* | −1.7, −2.7, −3.7, −4.7, | 4 | 28 |
| | −5.7, −6.7, −7.7 | | |
| Virus Control* | −1.7, −2.7, −3.7, −4.7, | 4 | 28 |
| (Control Substance + Virus) | −5.7, −6.7, −7.7 | | |
| Virucidal Test (treated)* | −1.7, −2.7, −3.7, −4.7, | 4 | 28 |
| (Test substance + Virus) | −5.7, −6.7, −7.7 | | |
| Cytotoxicity Control | −1.7, −2.7, −3.7 | 4 | 12 |
| (Test substance + Medium) | | | |
| Neutralization Control | −1.7, −2.7, −3.7 | 4 | 12 |
| (Neutralized test | | | |
| substance + Virus) | | | |

*Assayed in triplicate

Methods
1. Preparation of Test Substance

The control material did not contain the antiviral active ingredient under study. The test and control materials were approximately 2.5 cm×2.5 cm squares.

Preparation of bioassay test samples

The composition of virucides is the percent weight of the trilaminate unit.

Zinc citrate: Muslin cloth was soaked in an aqueous 10%

zinc citrate solution and air-dried, containing 2.5% zinc as 11% citrate salt dry weight content.

Wintergreen in Agar: Muslin cloth was soaked in a 2% agar solution in hot water. Excess solution was pressed out and air-dried. The surplus agar solution was recycled. Passages for ease of breathing were made by stretching the dry treatment diagonally. After drying, wintergreen was dropped on and allowed to spread into the layer to coat. The compounds comprised 3% of the unit.

Surfactant: The cellulosic laminate, infused with 0.2% sodium lauryl sulfate weight of the unit, was needle-perforated to insure free air passage.

Three laminates were permanently fused together along the top 2 mm edge to construct a trilaminate unit. The treated unit was cut to 1″ by 1″ squares, heat sterilized and vacuum-sealed in plastic bags.

Preparation of Bioassay Control Samples

Laminate 1: Muslin cloth was soaked in pure water and air-dried.

Laminate 2: Muslin cloth was soaked in pure water and air-dried.

Laminate 3: Cellulosic laminate was needle perforated, but not treated.

The three laminates were permanently fused together into a single unit along the top 2 mm edge. The package was heat sterilized and vacuum-sealed in plastic bags.

2. Input (Zero Time) Virus Control

On the day of testing, 0.1 ml aliquot of the test virus was inoculated onto each of three control fabric replicates at staggered intervals. Immediately, each replicate was transferred to individual tubes containing a 5.0 ml aliquot of test medium (a sufficient volume to completely cover the control) and mixed using a vortex type mixer for ≧30 seconds. Immediately a 0.1 ml aliquot was removed from each tube and the mixtures were titered by 10-fold serial dilution (0.1 ml+0.9 ml test medium) and assayed for infectivity to determine the input titer of the virus. The average TCID₅₀ result of the three replicates was used to calculate the percent and log reductions in viral titer of the test substance following the exposure time.

3. Virucidal Test

Each of the three replicates of the test substance contained in individual sterile Petri dishes were inoculated with a 0.1 ml aliquot of the test virus at staggered intervals. The test replicate remained covered at room temperature (20° C.) for fifteen minute exposure time. Immediately following the exposure time, the test samples were transferred to individual tubes containing a 5.0 ml aliquot of test medium (a sufficient volume to completely cover the test substance) and mixed using a vortex type mixer for ≧30 seconds. A 0.1 ml aliquot was removed from each tube and the mixtures were titered by 10-fold serial dilution (0.1 ml+0.9 ml test medium) and assayed for infectivity and/or cytotoxicity. The average TCID₅₀ result of the test replicates was determined and the percent and log reductions in virus titer following the fifteen minute exposure time were calculated.

4. Virus Control

Each of three replicates of the control substance contained in individual sterile Petri dishes were each inoculated with a 0.1 ml aliquot of the test virus at staggered intervals. The control replicate remained covered at 20° C. for fifteen minutes exposure time. Immediately following the exposure time, the control samples were transferred to individual tubes containing a 5 ml aliquot of test medium a sufficient volume to completely cover the control substance and mixed using a vortex type mixer for ≧30 seconds. A 0.1 ml aliquot was removed from each tube and the mixtures were titered by 10-fold serial dilution (0.1 ml+0.9 ml test medium) and assayed for infectivity. The average TCID₅₀ result of the control replicates was calculated. This control was performed for informational purposes only.

5. Cytotoxicity Control

A 0.1 ml aliquot of test substance containing 5% fetal bovine serum as the soil load in lieu of virus was inoculated onto one replicate of the test substance contained in a Petri dish. The dish was covered and the control was held for the fifteen minute exposure time at 20° C. Immediately following the exposure time, the test substance was transferred to a tube containing a 5 ml aliquot of test medium and mixed using a vortex type mixer for ≧30 seconds. A 0.1 ml aliquot was removed from the tube and the mixture was titered by 10-fold serial dilution (0.1 ml+0.9 ml test medium) and inoculated onto the indicator cell cultures to determine the level of cytotoxicity, if any, the system has on the indicator cell cultures.

6. Neutralization Control

Serial dilutions of diluted neutralize product (cytotoxicity control dilutions) were mixed with low titer stock virus. The resulting mixtures of dilutions were assayed for infectivity and/or cytotoxicity in order to determine the dilutions of product at which virucidal activity is retained. Dilutions that showed virucidal activity were not considered in determining reduction in infectivity by the product.

7. Negative Cell Control

For each set of test and controls, negative cell controls were employed consisting of test media alone to use as a reference when microscopically evaluating the indicator cell cultures.

8. Infectivity Assays

The RMK cell line, which exhibits CPE in the presence of H3N2 virus, was used as the indicator cell line in the infectivity assays. Cells in multiwell culture dishes were inoculated in quadruplicate with 0.1 ml of the dilutions prepared from all test and control groups. Uninfected indicator cell culture cell controls were inoculated with test medium alone. The cultures were incubated at 36°-38° C. in a humidified atmosphere of 5%-7% CO₂ in sterile disposable cell culture labware. The cultures were scored periodically for seven days for the absence or presence of CPE, cytotoxicity, and for viability.

Data Analysis

Calculation of Titers

Viral and cytotoxicity tests are expressed as −log₁₀ of the 50% titration endpoint for infectivity (TCID₅₀) or cytotoxicity (TCD₅₀), respectively, as calculated by the method of Spearman Karber.

$$Log of 1 st dilution inoculated - [ ( ( \frac{Sum of \% mortality at each dilution}{100} ) - 0.5 ) \times ( logarithm of dilution ) ]$$

Percent Reduction Formula

$$\% Reduction = 1 - [ \frac{Average {TCID}_{50} of the test}{{TCID}_{50} of the input ( zero time ) virus control} ] \times 100$$

Calculation of Log Reduction

Log Reduction=Average TCID₅₀ of the input (zero time) virus control−Average TCID₅₀ of the test

Study Acceptance Criteria

A valid test required 1) that infectivity be recovered from the input (zero time) virus control; 2) that the cell controls be negative for infectivity; and 3) that negative cultures be viable.

Study Results

Results of the tests with the mask exposed to H3N2 virus in the presence of a 5% fetal bovine serum soil load at 20° C. for fifteen minutes are shown in Tables 1-4. All cell controls were negative for test virus infectivity.

The titer of the input (zero time) control was 5.45 log₁₀ for Replicates #1 and #3, and 5.7 log₁₀ for Replicate .#2. The average titer of the three input (zero time) control replicates was 5.55 log₁₀.

The titer of the virus control held for fifteen minutes at 20° C./ was 5.45 log₁₀ for Replicate #1, 5.7 log₁₀ for Replicate #2, and 5.2 log₁₀ for Replicate #3. The average titer of the three virus control replicates was 5.50 log₁₀.

Following exposure, test virus infectivity was not detected in any of the three test substance replicates at any dilution tested (≦2.2 log₁₀). Test substance cytotoxicity was observed at 2.2 log₁₀. The neutralization control (non-virucidal level of the test substance) indicates that the test substance was neutralized at <2.2 log₁₀.

Taking the cytotoxicity and neutralization control results into consideration, the percent reduction in viral titer was ≧99.96% as compared to the average titer of the input (zero time) control. The average log reduction in viral titer is ≧3.35 log₁₀ as compared to the average titer of the input (zero time) control.

Accordingly, in the presence of 5% fetal bovine serum soil load, the instant mask demonstrated complete inactivation of H3N2 virus in all three test replicates following a fifteen minute exposure time at 20° C.

TABLE 1
Input Virus Control Results
Input (Zero Time) Virus Control Utilizing Non-Treated Carrier

| | Input (Zero Time) Virus Control | | |
|---|---|---|---|
| Dilution | Replicate #1 | Replicate #2 | Replicate #3 |
| Cell Control | 0 0 0 0 | 0 0 0 0 | 0 0 0 0 |
| 10^{-1.7} | + + + + | + + + + | + + + + |
| 10^{-2.7} | + + + + | + + + + | + + + + |
| 10^{-3.7} | + + + + | + + + + | + + + + |
| 10^{-4.7} | + + + + | + + + + | + + + + |
| 10^{-5.7} | 0 0 0 + | + 0 0 + | 0 0 0 + |
| 10^{-6.7} | 0 0 0 0 | 0 0 0 0 | 0 0 0 0 |
| 10^{-7.7} | 0 0 0 0 | 0 0 0 0 | 0 0 0 0 |
| TCID₅₀/0.1 mL | 10^{5.45} | 10^{5.7} | 10^{5.45} |

TABLE 2
Virus Control Results
Virus Control Held for Fifteen
Minute Exposure Time Utilizing Non-Treated Carrier

| | Virus Control − 15 Minute Exposure Time | | |
|---|---|---|---|
| Dilution | Replicate #1 | Replicate #2 | Replicate #3 |
| Cell Control | 0 0 0 0 | 0 0 0 0 | 0 0 0 0 |
| 10^{-1.7} | + + + + | + + + + | + + + + |
| 10^{-2.7} | + + + + | + + + + | + + + + |
| 10^{-3.7} | + + + + | + + + + | + + + + |
| 10^{-4.7} | + + + + | + + + + | + + 0 + |
| 10^{-5.7} | 0 0 0 + | 0 + 0 0 | 0 0 0 + |
| 10^{-6.7} | 0 0 0 0 | 0 0 0 0 | 0 0 0 0 |
| 10^{-7.7} | 0 0 0 0 | + 0 0 0 | 0 0 0 0 |
| TCID₅₀/0.1 mL | 10^{5.45} | 10^{5.7} | 10^{5.2} |

(+) = Positive for the presence of test virus
(0) = No test virus recovered and/or no cytotoxicity present

TABLE 3
Test Results
Effects of iCare Mask Following a Fifteen
Minute Exposure to Avian Influenza A (H3N2) Virus
(Avian Reassortant) Dried on an Inanimate Surface

| | iCare Mask + | | |
|---|---|---|---|
| | Avian Influenza A (H3N2) virus (Avian Reassortant) | | |
| Dilution | Replicate #1 | Replicate #2 | Replicate #3 |
| Cell Control | 0 0 0 0 | 0 0 0 0 | 0 0 0 0 |
| 10^{-1.7} | T T T T | T T T T | T T T T |
| 10^{-2.7} | 0 0 0 0 | 0 0 0 0 | 0 0 0 0 |
| 10^{-3.7} | 0 0 0 0 | 0 0 0 0 | 0 0 0 0 |
| 10^{-4.7} | 0 0 0 0 | 0 0 0 0 | 0 0 0 0 |
| 10^{-5.7} | 0 0 0 0 | 0 0 0 0 | 0 0 0 0 |
| 10^{-6.7} | 0 0 0 0 | 0 0 0 0 | 0 0 0 0 |
| 10^{-7.7} | 0 0 0 0 | 0 0 0 0 | 0 0 0 0 |
| TCID₅₀/0.1 mL | ≦10^{2.2} | ≦10^{2.2} | ≦10^{2.2} |

TABLE 4
Cytotoxicity Control and Neutralization Control Results

| Dilution | Cytotoxicity Control | Neutralization Control |
|---|---|---|
| Cell Control | 0 0 0 0 | 0 0 0 0 |
| 10^{-1.7} | T T T T | T T T T |
| 10^{-2.7} | 0 0 0 0 | + + + + |
| 10^{-3.7} | 0 0 0 0 | + + + + |
| TCD₅₀/0.1 mL | 10^{2.2} | See below |

(+) = Positive for the presence of test virus
(0) = No test virus recovered and/or no cytotoxicity present
(T) = Cytotoxicity present

What is claimed is:

1. A mask, comprising:
a plurality of layers, wherein a first layer comprises an acid or a salt or ester thereof, and a second layer comprises a base or a salt or ester thereof.

2. The mask of claim 1, further comprising a third layer.

3. The mask of claim 2, wherein said third layer comprises a metallic germicide.

4. The mask of claim 3, wherein said metallic germicide is selected from the group consisting of zinc, copper, nickel, iodine, manganese, tin, boron, silver, salts thereof, chelants, chelactants, surfactant-linked compositions thereof and ions.

5. The mask of claim 2, wherein said third layer comprises a deodorant.

6. The mask of claim 5, wherein said deodorant is selected from the group consisting of wintergreen, spearmint, peppermint, eucalyptol, cedar, pinene, tree oils, limonene and citrus oils.

7. The mask of claim 1, wherein said acid is selected from the group consisting of citric acid, carboxylic acid, a Krebs Cycle acid and mineral acid.

8. The mask of claim 2, wherein said third layer comprises a surfactant.

9. The mask of claim 8 wherein the surfactant is selected from the group consisting of sodium lauryl sulfate, quaternary ammonium salts, anionic surfactants, cationic surfactants, nonionic surfactants, and soaps.

10. The mask of claim 1, further comprising a perforated phycocolloid layer.

11. The mask of claim 1, wherein said first layer further comprises a phycocolloid.

12. The mask of claim 1, wherein said first and second layers comprise woven materials.

13. The mask of claim 1, wherein said first layer comprises woven microfibril cloth.

14. The mask of claim 1, wherein said second layer comprises woven cotton cloth.

15. The mask of claim 1, further comprising a fastener adapted to hold said mask over the mouth and nose of a wearer.

16. The mask of claim 15, further comprising a second fastener, wherein each of said fasteners is loop shaped and adapted to be placed behind a respective ear of the user.

17. A method of preventing the contraction and spread of viruses and germs by a user, comprising:
providing a mask comprising:
a plurality of layers, wherein a first layer comprises an acid or a salt or ester thereof, and a second layer comprises a base or a salt or ester thereof;
securing said mask over the nose and mouth of said user; and
inhaling and exhaling through said mask.

18. The method of claim 17, wherein said mask further comprises a fastener adapted to hold said mask over the mouth and nose of a wearer.

19. The mask of claim 18, further comprising a second fastener, wherein each of said fasteners is loop shaped and adapted to be placed behind a respective ear of the user.

20. The method of claim 17, wherein said virus is Avian Influenza.

21. The method of claim 17, wherein said a plurality of layers stop at least about 95% of particulates and prevent leakage of at least about 95% of particulates of 0.3 micron diameter.

22. The method of claim 17, wherein said plurality of layers stop at least about 99.97% of particulates and prevent leakage of at least about 99.97% of particulates of 0.3 micron diameter.

23. The method of claim 21, wherein said particulates are viral particles.
